(19) United States
(12) Patent Application Publication
(10) Pub. No.: US 2024/0257998 A1
(43) Pub. Date: Aug. 1, 2024

(54) CHIP RESISTOR

(71) Applicant: ROHM CO., LTD., Kyoto-shi (JP)

(72) Inventor: Takanori SHINOURA, Kyoto-shi (JP)

(21) Appl. No.: 18/629,453

(22) Filed: Apr. 8, 2024

Related U.S. Application Data
(63) Continuation of application No. PCT/JP22/36708, filed on Sep. 30, 2022.

(30) Foreign Application Priority Data
Nov. 2, 2021 (JP) 2021-179473
Nov. 2, 2021 (JP) 2021-179474
Nov. 18, 2021 (JP) 2021-188124

(51) Int. Cl. H01C 1/032; H01C 1/14

(52) U.S. Cl. CPC H01C 1/032; H01C 1/14

(57) ABSTRACT

A chip resistor includes: an insulating substrate having a first main surface, a first side surface, and a second side surface, the first main surface being an end surface in a thickness direction of the chip resistor, and the first side surface and the second side surface each being an end surface in a longitudinal direction of the chip resistor; a first front surface electrode disposed on an end portion of the first main surface on a side close to the first side surface; a second front surface electrode disposed on an end portion of the first main surface on a side close to the second side surface; a resistor body disposed on the first main surface and electrically connected to the first front surface electrode and the second front surface electrode.

### TECHNICAL FIELD

The present disclosure relates to a chip resistor.

### BACKGROUND ART

A chip resistor disclosed in Japanese Patent Laying-Open No. 2020-170747 (PTL 1) includes an insulating substrate, a first upper surface electrode and a second upper surface electrode, a resistor body, a protective film, a first back surface electrode and a second back surface electrode, a first end surface electrode and a second end surface electrode, and a first plating layer and a second plating layer. The insulating substrate has a first main surface, a second main surface, a first side surface, and a second side surface. The first side surface and the second side surface are end surfaces of the chip resistor disclosed in PTL 1 in its longitudinal direction (hereinafter referred to as a “longitudinal direction”).

The first and second upper surface electrodes are disposed on respective end portions of the first main surface on the first and second side surface sides. The resistor body is disposed on the first main surface and electrically connected to the first upper surface electrode and the second upper surface electrode. The protective film is disposed on the resistor body. Both end portions of the protective film in the longitudinal direction respectively extend on the first upper surface electrode and the second upper surface electrode. The first and second back surface electrodes are disposed on respective end portions of the second main surface on the first and second side surface sides.

The first end surface electrode is disposed on the first side surface, the first upper surface electrode, and the first back surface electrode. The first upper surface electrode and the first back surface electrode are electrically connected by the first end surface electrode. The second end surface electrode is disposed on the second side surface, the second upper surface electrode, and the second back surface electrode. The second upper surface electrode and the second back surface electrode are electrically connected by the second end surface electrode.

The first plating layer covers the first end surface electrode, a portion of the first upper surface electrode that is exposed from the first end surface electrode, and a portion of the first back surface electrode that is exposed from the first end surface electrode. The second plating layer covers the second end surface electrode, a portion of the second upper surface electrode that is exposed from the second end surface electrode, and a portion of the second back surface electrode that is exposed from the second end surface electrode.

### CITATION LIST

### Patent Literature

PTL 1: Japanese Patent Laying-Open No. 2020-170747

### SUMMARY

The chip resistor disclosed in PTL 1 is mounted on a circuit board having a first land and a second land. More specifically, in the chip resistor disclosed in PTL 1, a bonding member such as a solder alloy bonds the first plating layer and the first land, and also bonds the second plating layer and the second land.

In the chip resistor disclosed in PTL 1, heat generated in the resistor body is dissipated from the circuit board through the protective film, the first plating layer (the second plating layer), and the bonding member. However, since the thermal conductivity of the protective film is relatively low, there is still room for improvement in heat dissipation performance of the resistor body in the chip resistor disclosed in PTL 1.

A chip resistor of the present disclosure includes: an insulating substrate having a first main surface, a first side surface, and a second side surface, the first main surface being an end surface in a thickness direction of the chip resistor, and the first side surface and the second side surface each being an end surface in a longitudinal direction of the chip resistor; a first front surface electrode disposed on an end portion of the first main surface on a side close to the first side surface; a second front surface electrode disposed on an end portion of the first main surface on a side close to the second side surface; a resistor body disposed on the first main surface and electrically connected to the first front surface electrode and the second front surface electrode; a protective film disposed on the resistor body to partially cover the first front surface electrode and the second front surface electrode; a first conductive resin layer disposed to extend over the first front surface electrode and the protective film; and a second conductive resin layer disposed to extend over the second front surface electrode and the protective film. An end of the first conductive resin layer on the side close to the second side surface is spaced apart from an end of the second conductive resin layer on the side close to the first side surface.

### BRIEF DESCRIPTION OF DRAWINGS

FIG. 1 is a plan view of a chip resistor 100.

FIG. 2 is a cross-sectional view taken along a line II-II in FIG. 1.

FIG. 3A is a first cross-sectional view of chip resistor 100 mounted on a circuit board 200.

FIG. 3B is a second cross-sectional view of chip resistor 100 mounted on circuit board 200.

FIG. 4 is a process diagram showing a method of manufacturing chip resistor 100.

FIG. 5 is a plan view of a sheet-like substrate 11.

FIG. 6 is a bottom view of sheet-like substrate 11.

FIG. 7 is a cross-sectional view for illustrating a first electrode forming step S2.

FIG. 8 is a cross-sectional view for illustrating a resistor body forming step S3.

FIG. 9 is a cross-sectional view for illustrating a protective film forming step S4.

FIG. 10 is a cross-sectional view for illustrating a conductive resin layer forming step S5.

FIG. 11 is a cross-sectional view for illustrating a first dividing step S6.

FIG. 12 is a cross-sectional view for illustrating a second electrode forming step S7.

FIG. 13 is a cross-sectional view for illustrating a second dividing step S8.

FIG. 14 is a cross-sectional view of a chip resistor 100A.

FIG. 15 is a cross-sectional view of a chip resistor 100B.

FIG. 16 is a top view of a chip resistor 100C.

FIG. 17 is a bottom view of chip resistor 100C.

FIG. 18 is a cross-sectional view taken along a line XVIII-XVIII in FIG. 16.

FIG. 19 is a process diagram showing a method of manufacturing chip resistor 100C.

FIG. 20 is a cross-sectional view for illustrating first electrode forming step S2 in the method of manufacturing chip resistor 100C.

FIG. 21 is a bottom view of a chip resistor 100D.

FIG. 22 is a cross-sectional view taken along a line XXII-XXII in FIG. 21.

FIG. 23 is a bottom view of a chip resistor 100E.

FIG. 24 is a cross-sectional view taken along a line XXIV-XXIV in FIG. 23.

FIG. 25 is a top view of a chip resistor 100F.

FIG. 26 is a bottom view of chip resistor 100F.

FIG. 27 is a cross-sectional view taken along a line XXVII-XXVII in FIG. 25.

FIG. 28 is a cross-sectional view for illustrating a resistor body forming step S3 in a method of manufacturing chip resistor 100F.

FIG. 29 is a cross-sectional view for illustrating a protective film forming step S4 in the method of manufacturing chip resistor 100F.

FIG. 30 is a cross-sectional view of a chip resistor 100G.

FIG. 31 is a cross-sectional view of a chip resistor 100H.

### DESCRIPTION

Embodiments of the present disclosure will be hereinafter described in detail with reference to the accompanying drawings. In the accompanying drawings, the same or corresponding portions are denoted by the same reference characters, and the same description will not be repeated.

### First Embodiment

A chip resistor according to the first embodiment will be described below. The chip resistor according to the first embodiment is referred to as a chip resistor 100.

### <Configuration of Chip Resistor 100>

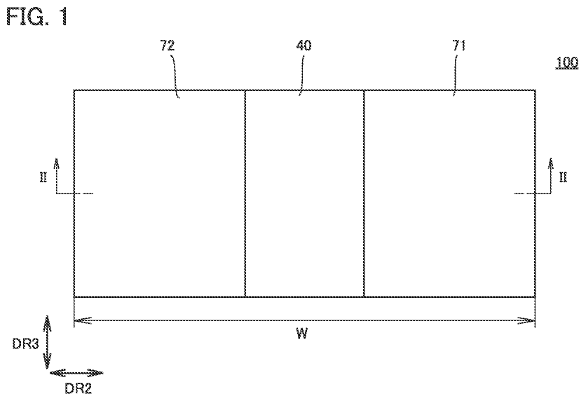

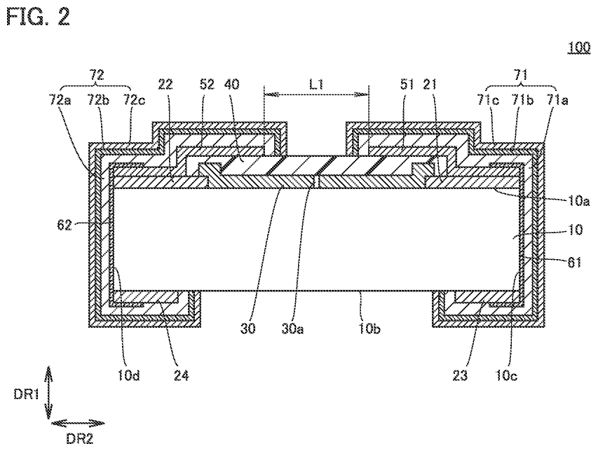

FIG. 1 is a plan view of a chip resistor 100. FIG. 2 is a cross-sectional view taken along a line II-II in FIG. 1. As shown in FIGS. 1 and 2, chip resistor 100 includes an insulating substrate 10, a first front surface electrode 21 and a second front surface electrode 22, a first back surface electrode 23 and a second back surface electrode 24, a resistor body 30, a protective film 40, a first conductive resin layer 51 and a second conductive resin layer 52, a first side surface electrode 61 and a second side surface electrode 62, and a first plating layer 71 and a second plating layer 72.

The thickness direction of chip resistor 100 is referred to as a first direction DR1. The longitudinal direction of chip resistor 100 is referred to as a second direction DR2. Second direction DR2 is orthogonal to first direction DR1, for example. The width direction of chip resistor 100 is referred to as a third direction DR3. Third direction DR3 is orthogonal to first direction DR1 and second direction DR2.

Insulating substrate 10 is made of an insulating material. Insulating substrate 10 is preferably made of a material having high thermal conductivity. Insulating substrate 10 is made, for example, of a ceramic material such as alumina (Al₂O₃). The longitudinal direction of insulating substrate 10 extends in second direction DR2. Insulating substrate 10 has, for example, a rectangular shape in a plan view.

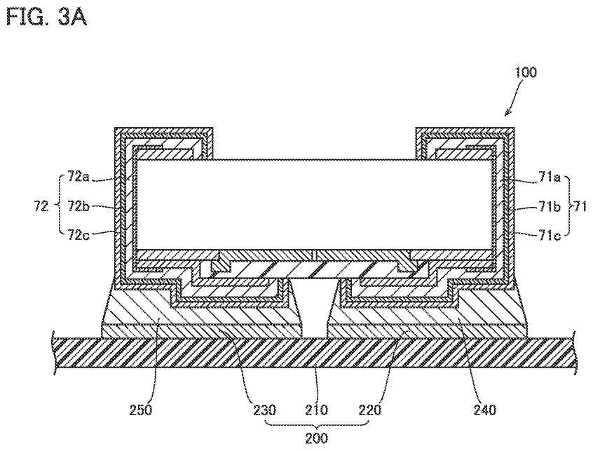

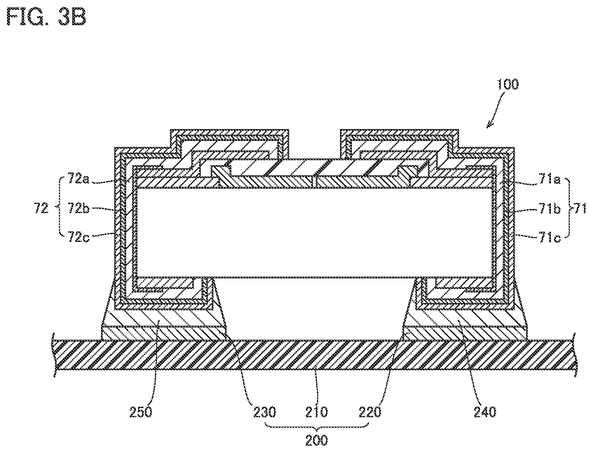

Insulating substrate 10 has a first main surface 10a, a second main surface 10b, a first side surface 10c, and a second side surface 10d. First main surface 10a and second main surface 10b are end surfaces of insulating substrate 10 in first direction DR1. Second main surface 10b is a surface opposite to first main surface 10a. When insulating substrate 10 is mounted on a circuit board 200, first main surface 10a faces circuit board 200 (see FIG. 3A). When insulating substrate 10 is mounted on circuit board 200, second main surface 10b may face circuit board 200 (see FIG. 3B). First side surface 10c and second side surface 10d are end surfaces of insulating substrate 10 in second direction DR2. Second side surface 10d is a surface opposite to first side surface 10c.

First front surface electrode 21 and second front surface electrode 22 each are made of a conductive material. First front surface electrode 21 and second front surface electrode 22 each are made, for example, of burned metal particles. The metal particles are, for example, silver (Ag) particles.

First front surface electrode 21 and second front surface electrode 22 are disposed on first main surface 10a. More specifically, first front surface electrode 21 is disposed on an end portion of first main surface 10a on the side close to first side surface 10c, and second front surface electrode 22 is disposed on an end portion of first main surface 10a on the side close to second side surface 10d. First front surface electrode 21 and second front surface electrode 22 are spaced apart from each other in second direction DR2. In other words, first main surface 10a is exposed from between first front surface electrode 21 and second front surface electrode 22.

First back surface electrode 23 and second back surface electrode 24 each are made of a conductive material. First back surface electrode 23 and second back surface electrode 24 each are made, for example, of burned metal particles. The metal particles are, for example, silver particles.

First back surface electrode 23 and second back surface electrode 24 are disposed on second main surface 10b. More specifically, first back surface electrode 23 is disposed on an end portion of second main surface 10b on the side close to first side surface 10c, and second back surface electrode 24 is disposed on an end portion of second main surface 10b on the side close to second side surface 10d. First back surface electrode 23 and second back surface electrode 24 are spaced apart from each other in second direction DR2. In other words, second main surface 10b is exposed from between first back surface electrode 23 and second back surface electrode 24.

Resistor body 30 is made of a conductive material. Resistor body 30 is made, for example, of burned conductive particles. Examples of the conductive particles include silver-palladium (Pd) alloy particles, copper (Cu)-nickel (Ni) alloy particles, ruthenium oxide (RuO₂) particles, and the like.

Resistor body 30 is disposed on first main surface 10a between first front surface electrode 21 and second front surface electrode 22. Both ends of resistor body 30 in second direction DR2 may respectively extend on an end portion of first front surface electrode 21 on the side close to second side surface 10d and an end portion of second front surface electrode 22 on the side close to first side surface 10c. Resistor body 30 is electrically connected to first front surface electrode 21 and second front surface electrode 22.

Resistor body 30 is provided with a trimming groove 30a. Trimming groove 30a penetrates resistor body 30 in the thickness direction. Trimming groove 30a extends, for example, in third direction DR3. The electrical resistance value of resistor body 30 is adjusted by adjusting the length of trimming groove 30a.

Protective film 40 is made of an insulating material. Protective film 40 is made, for example, of a resin material such as an epoxy resin or a phenol resin. Protective film 40 is disposed on resistor body 30. Both ends of protective film 40 in second direction DR2 may respectively extend on first front surface electrode 21 and second front surface electrode 22. However, first front surface electrode 21 and second front surface electrode 22 are exposed from protective film 40.

First conductive resin layer 51 and second conductive resin layer 52 each are made of a conductive resin. This conductive resin is made of a resin material and conductive particles. The resin material is, for example, an epoxy resin and the like, and the conductive particles are, for example, silver-palladium alloy particles or copper-nickel alloy particles. First conductive resin layer 51 and second conductive resin layer 52 are higher in thermal conductivity than protective film 40.

First conductive resin layer 51 and second conductive resin layer 52 are spaced apart from each other in second direction DR2. Trimming groove 30a is located between first conductive resin layer 51 and second conductive resin layer 52 in second direction DR2. First conductive resin layer 51 is disposed to extend over first front surface electrode 21 and protective film 40. First conductive resin layer 51 is disposed, for example, to cover first front surface electrode 21. Second conductive resin layer 52 is disposed to extend over second front surface electrode 22 and protective film 40. Second conductive resin layer 52 is disposed, for example, to cover second front surface electrode 22. An end of first conductive resin layer 51 on the side close to second side surface 10d and an end of second conductive resin layer 52 on the side close to first side surface 10c preferably overlap with resistor body 30 in a plan view.

A width W represents the width of chip resistor 100 in second direction DR2. A distance L1 represents the distance in second direction DR2 between the end of first conductive resin layer 51 on the side close to second side surface 10d and the end of second conductive resin layer 52 on the side close to first side surface 10c. Distance L1 is preferably 300 μm or more and 700 μm or less. The value obtained by dividing distance L1 by width W is preferably 0.0938 or more and 0.2188 or less.

First side surface electrode 61 and second side surface electrode 62 each are made of a conductive material. First side surface electrode 61 and second side surface electrode 62 each are made, for example, of a nickel-chromium (Cr) alloy. First side surface electrode 61 and second side surface electrode 62 each are, for example, a sputtering film.

First side surface electrode 61 is disposed on first side surface 10c. First side surface electrode 61 is disposed also on an end portion of first front surface electrode 21 on the side close to first side surface 10c and on an end portion of first back surface electrode 23 on the side close to first side surface 10c. First side surface electrode 61 electrically connects first front surface electrode 21 and first back surface electrode 23. Second side surface electrode 62 is disposed on second side surface 10d. Second side surface electrode 62 is disposed also on an end portion of second front surface electrode 22 on the side close to second side surface 10d and an end portion of second back surface electrode 24 on the side close to second side surface 10d. Second side surface electrode 62 electrically connects second front surface electrode 22 and second back surface electrode 24.

First plating layer 71 is constituted of a first layer 71a, a second layer 71b, and a third layer 71c. Second plating layer 72 is constituted of a first layer 72a, a second layer 72b, and a third layer 72c. First layer 71a is disposed to cover first front surface electrode 21, first back surface electrode 23, first conductive resin layer 51, and first side surface electrode 61. Second layer 71b is disposed on first layer 71a. Third layer 71c is disposed on second layer 71b. First layer 72a is disposed to cover second front surface electrode 22, second back surface electrode 24, second conductive resin layer 52, and second side surface electrode 62. Second layer 72b is disposed on first layer 72a. Third layer 72c is disposed on second layer 72b.

First layers 71a and 72a are made of copper, for example. Second layers 71b and 72b are made of nickel, for example. Third layers 71c and 72c are made of tin (Sn), for example.

FIG. 3A is a first cross-sectional view of chip resistor 100 mounted on circuit board 200. FIG. 3B is a second cross-sectional view of chip resistor 100 mounted on circuit board 200. As shown in FIGS. 3A and 3B, circuit board 200 includes a base member 210, a first land 220, and a second land 230. Base member 210 is made of an insulating material such as an epoxy resin containing glass fibers. First land 220 and second land 230 are disposed on a main surface of base member 210. First land 220 and second land 230 each are made, for example, of a conductive material such as copper. Chip resistor 100 may be disposed such that first main surface 10a faces circuit board 200 or may be disposed such that second main surface 10b faces circuit board 200.

Chip resistor 100 is mounted on circuit board 200. More specifically, first plating layer 71 is bonded to first land 220 by a bonding member 240, and second plating layer 72 is bonded to second land 230 by a bonding member 250. Bonding members 240 and 250 each are made, for example, of a tin alloy.

### <Method of Manufacturing Chip Resistor 100>

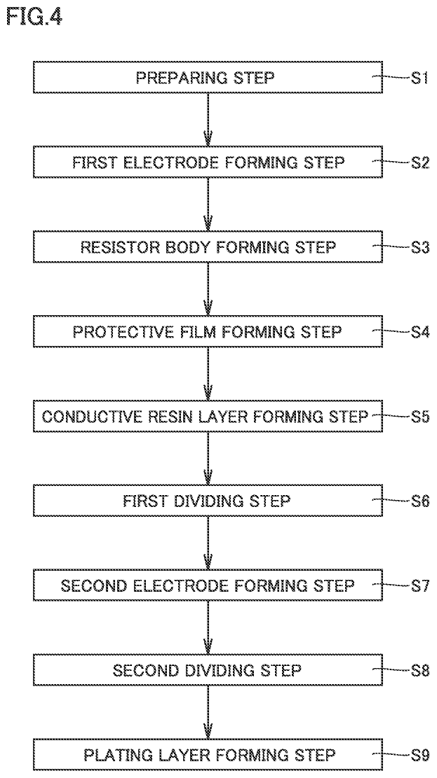

FIG. 4 is a process diagram showing a method of manufacturing chip resistor 100. As shown in FIG. 4, the method of manufacturing chip resistor 100 includes a preparing step S1, a first electrode forming step S2, a resistor body forming step S3, a protective film forming step S4, and a conductive resin layer forming step S5. The method of manufacturing chip resistor 100 further includes a first dividing step S6, a second electrode forming step S7, a second dividing step S8, and a plating layer forming step S9.

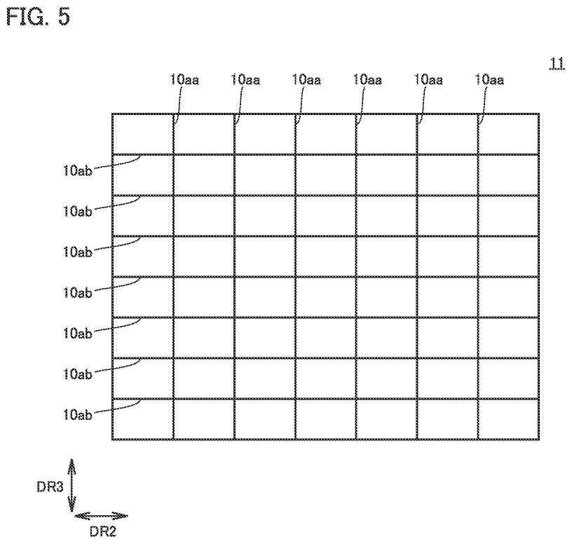

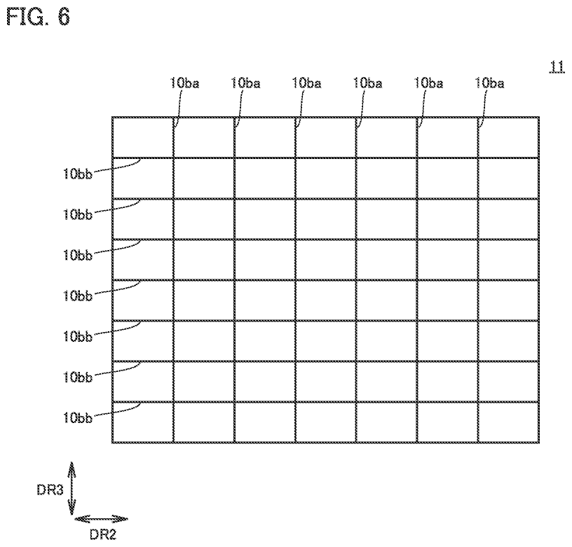

In preparing step S1, a sheet-like substrate 11 is prepared. FIG. 5 is a plan view of sheet-like substrate 11. FIG. 6 is a bottom view of sheet-like substrate 11. As shown in FIGS. 5 and 6, sheet-like substrate 11 has first main surface 10a and second main surface 10b. Sheet-like substrate 11 is made of the same material as insulating substrate 10.

First main surface 10a is provided with a plurality of first dividing grooves 10aa and a plurality of second dividing grooves 10ab. Second main surface 10b is provided with a plurality of first dividing grooves 10ba and a plurality of second dividing grooves 10bb.

Each of the plurality of first dividing grooves 10aa and each of the plurality of first dividing grooves 10ba extend in third direction DR3. The plurality of first dividing grooves 10aa are arranged at regular intervals in second direction DR2. One dividing groove and the other dividing groove of two first dividing grooves 10aa adjacent to each other are referred to as a first dividing groove 10aaa and a first dividing groove 10aab, respectively. The plurality of first dividing grooves 10ba are arranged at regular intervals in second direction DR2. One dividing groove and the other dividing groove of two first dividing grooves 10ba adjacent to each other are referred to as a first dividing groove 10baa and a first dividing groove 10bab, respectively. The position of each of first dividing grooves 10aa in second direction DR2 coincides with the position of a corresponding one of first dividing grooves 10ba in second direction DR2.

Each of the plurality of second dividing grooves 10ab and each of the plurality of second dividing grooves 10bb extend in second direction DR2. The plurality of second dividing grooves 10ab are arranged at regular intervals in third direction DR3. The plurality of second dividing grooves 10bb are arranged at regular intervals in third direction DR3. The position of each of second dividing grooves 10ab in third direction DR3 coincides with the position of a corresponding one of second dividing grooves 10bb in third direction DR3.

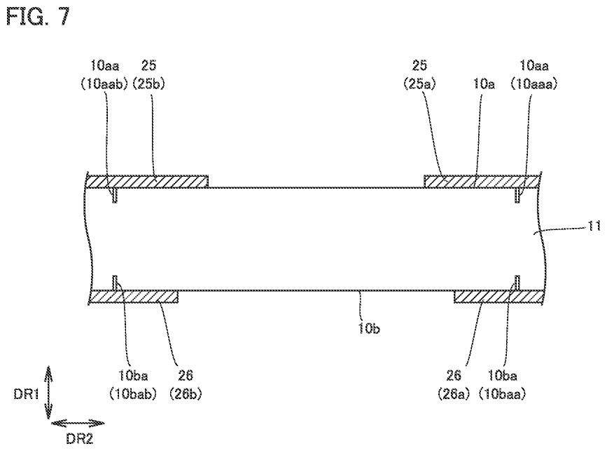

First electrode forming step S2 is performed after preparing step S1. FIG. 7 is a cross-sectional view for illustrating first electrode forming step S2. As shown in FIG. 7, in first electrode forming step S2, a front surface electrode 25 is formed on first main surface 10a, and a back surface electrode 26 is formed on second main surface 10b. Front surface electrode 25 is formed to extend over first dividing groove 10aa, and back surface electrode 26 is formed to extend over first dividing groove 10ba.

Front surface electrode 25 formed to extend over first dividing groove 10aaa and front surface electrode 25 formed to extend over first dividing groove 10aab are referred to as a front surface electrode 25a and a front surface electrode 25b, respectively. Back surface electrode 26 formed to extend over first dividing groove 10baa and back surface electrode 26 formed to extend over first dividing groove 10bab are referred to as a back surface electrode 26a and a back surface electrode 26b, respectively.

Front surface electrodes 25a and 25b are arranged at intervals in second direction DR2. Back surface electrodes 26a and 26b are arranged at intervals in second direction DR2. Front surface electrode 25 and back surface electrode 26 are formed by applying a paste containing metal particles such as silver particles and then burning the applied paste.

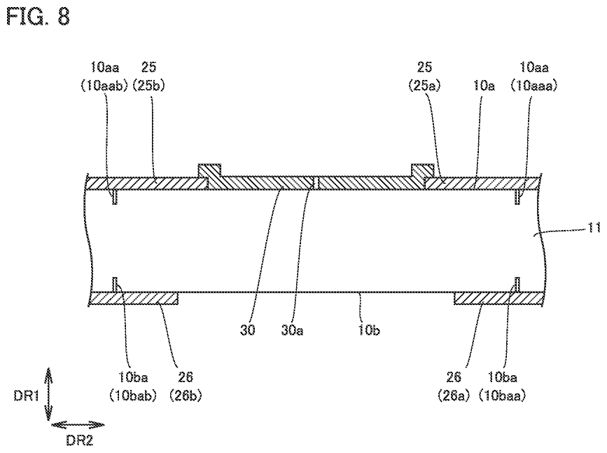

Resistor body forming step S3 is performed after first electrode forming step S2. FIG. 8 is a cross-sectional view for illustrating resistor body forming step S3. As shown in FIG. 8, resistor body 30 is formed in resistor body forming step S3. Resistor body 30 is formed on a portion of first main surface 10a that is located between front surface electrodes 25a and 25b such that both ends of resistor body 30 in second direction DR2 are respectively located on front surface electrodes 25a and 25b. Resistor body 30 is formed by applying a paste containing conductive particles such as silver-palladium alloy particles and then burning the applied paste.

In resistor body forming step S3, after resistor body 30 is formed, for example, trimming groove 30a is formed by irradiation with a laser beam to thereby adjust the electrical resistance value of resistor body 30.

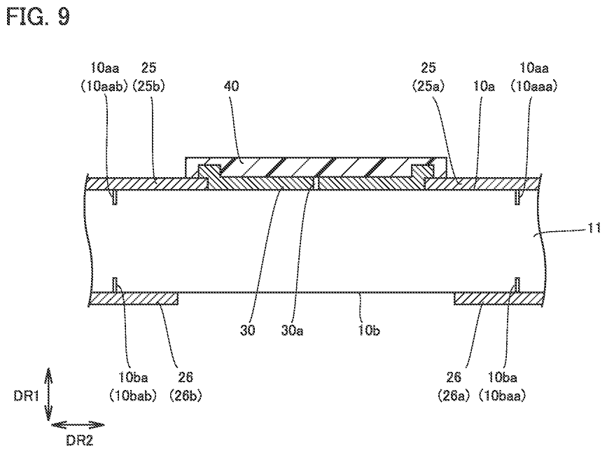

Protective film forming step S4 is performed after resistor body forming step S3. FIG. 9 is a cross-sectional view for illustrating protective film forming step S4. As shown in FIG. 9, protective film 40 is formed in protective film forming step S4. Protective film 40 is formed on resistor body 30 such that both ends of protective film 40 in second direction DR2 are respectively located on front surface electrodes 25a and 25b. Protective film 40 is formed by applying an uncured resin material and then heating and curing the applied resin material.

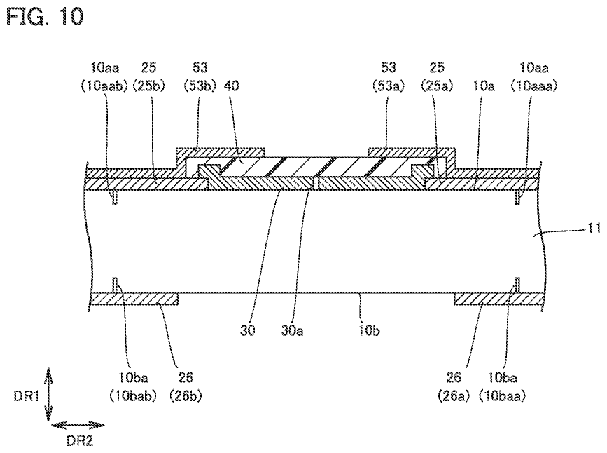

Conductive resin layer forming step S5 is performed after protective film forming step S4. FIG. 10 is a cross-sectional view for illustrating conductive resin layer forming step S5. As shown in FIG. 10, in conductive resin layer forming step S5, a conductive resin layer 53 is formed to extend over front surface electrode 25 and protective film 40. Conductive resin layer 53 formed to extend over front surface electrode 25a and protective film 40 is referred to as a conductive resin layer 53a, and conductive resin layer 53 formed to extend over front surface electrode 25b and protective film 40 is referred to as a conductive resin layer 53b. Conductive resin layer 53 is formed by applying an uncured resin material containing conductive particles over front surface electrode 25 and protective film 40, and then heating and curing the applied uncured resin material.

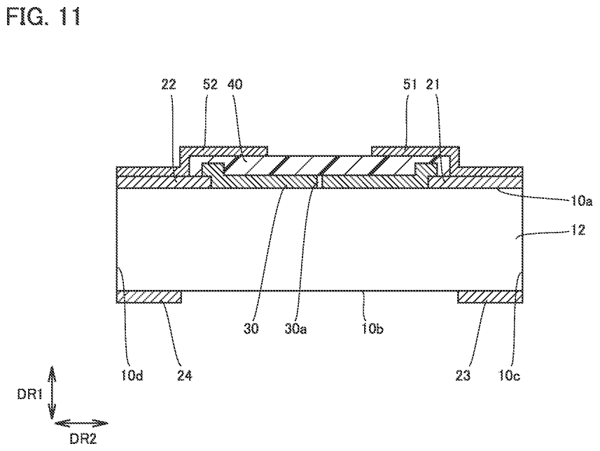

First dividing step S6 is performed after conductive resin layer forming step S5. FIG. 11 is a cross-sectional view for illustrating first dividing step S6. As shown in FIG. 11, in first dividing step S6, sheet-like substrate 11 is divided along first dividing grooves 10aa and first dividing grooves 10ba and thereby separated into a plurality of strip-shaped substrates 12. The surfaces along which strip-shaped substrate 12 is divided are defined as first side surface 10c and second side surface 10d.

By dividing sheet-like substrate 11, a portion of front surface electrode 25a on the side close to first dividing groove 10aab and a portion of front surface electrode 25b on the side close to first dividing groove 10aaa are provided as first front surface electrode 21 and second front surface electrode 22, respectively, and a portion of back surface electrode 26a on the side close to first dividing groove 10bab and a portion of back surface electrode 26b on the side close to first dividing groove 10baa are provided as first back surface electrode 23 and second back surface electrode 24, respectively. Further, by dividing sheet-like substrate 11, a portion of conductive resin layer 53a on the side close to first dividing groove 10aab and a portion of conductive resin layer 53b on the side close to first dividing groove 10aaa are provided as first conductive resin layer 51 and second conductive resin layer 52, respectively.

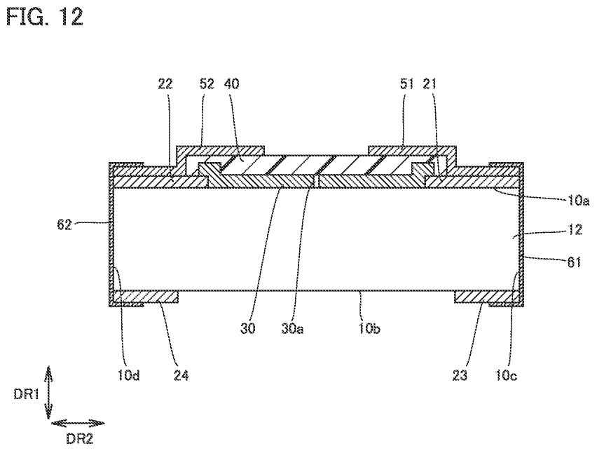

Second electrode forming step S7 is performed after first dividing step S6. FIG. 12 is a cross-sectional view for illustrating second electrode forming step S7. As shown in FIG. 12, in second electrode forming step S7, first side surface electrode 61 is formed on first side surface 10c, and second side surface electrode 62 is formed on second side surface 10d. First side surface electrode 61 and second side surface electrode 62 are formed, for example, by sputtering.

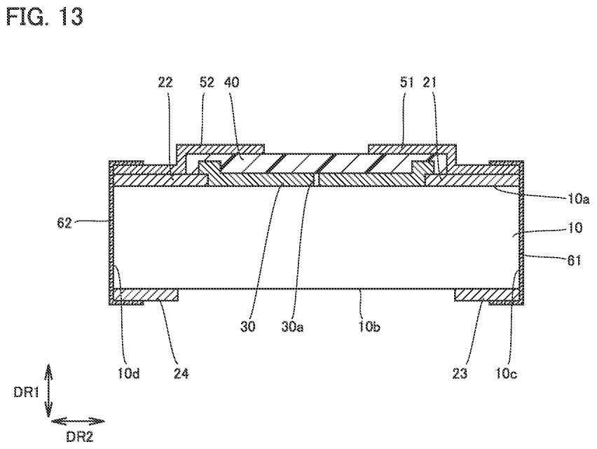

Second dividing step S8 is performed after second electrode forming step S7. FIG. 13 is a cross-sectional view for illustrating second dividing step S8. As shown in FIG. 13, in second dividing step S8, strip-shaped substrate 12 is divided along second dividing grooves 10ab and second dividing grooves 10bb and thereby separated into a plurality of insulating substrates 10. Plating layer forming step S9 is performed after second dividing step S8. In plating layer forming step S9, first layer 71a, second layer 71b, and third layer 71c are sequentially formed. In plating layer forming step S9, first layer 72a, second layer 72b, and third layer 72c are also sequentially formed. In the manner as described above, chip resistor 100 having the structure shown in FIGS. 1 and 2 is manufactured.

### <Effects of Chip Resistor 100>

The heat generated in resistor body 30 is dissipated from circuit board 200 through bonding member 240 (bonding member 250). At this time, for example, in the case where first main surface 10a faces circuit board 200, the heat generated in resistor body 30 flows through protective film 40, first conductive resin layer 51 (second conductive resin layer 52), first front surface electrode 21 (second front surface electrode 22), and first plating layer 71 (second plating layer 72), and reaches bonding member 240 (bonding member 250).

First conductive resin layer 51 (second conductive resin layer 52) is higher in thermal conductivity than protective film 40. Thus, in chip resistor 100, the heat generated in resistor body 30 is easily dissipated from circuit board 200 through bonding member 240 (bonding member 250), so that the heat dissipation performance of resistor body 30 is improved.

As distance L1 becomes smaller, the area of overlapping between first conductive resin layer 51 and resistor body 30 (protective film 40) becomes larger and the area of overlapping between second conductive resin layer 52 and resistor body 30 (protective film 40) becomes larger, and thereby, the heat generated in resistor body 30 is easily transferred to first conductive resin layer 51 and second conductive resin layer 52. On the other hand, when the distance between first conductive resin layer 51 and second conductive resin layer 52 becomes too small, first conductive resin layer 51 and second conductive resin layer 52 may come into contact with each other due to an error and the like caused during manufacturing, which may cause a short circuit between first front surface electrode 21 and second front surface electrode 22. Thus, the value obtained by dividing distance L1 by width W is set to be 0.0938 or more and 0.2188 or less (distance L1 is set to be 300 μm or more and 700 μm or less), which makes it possible to improve the heat dissipation performance of resistor body 30 while preventing a short circuit between first front surface electrode 21 and second front surface electrode 22.

### Second Embodiment

The following describes a chip resistor according to the second embodiment. The chip resistor according to the second embodiment is referred to as a chip resistor 100A. The following mainly describes differences from chip resistor 100 and the same description will not be repeated.

### <Configuration of Chip Resistor 100A>

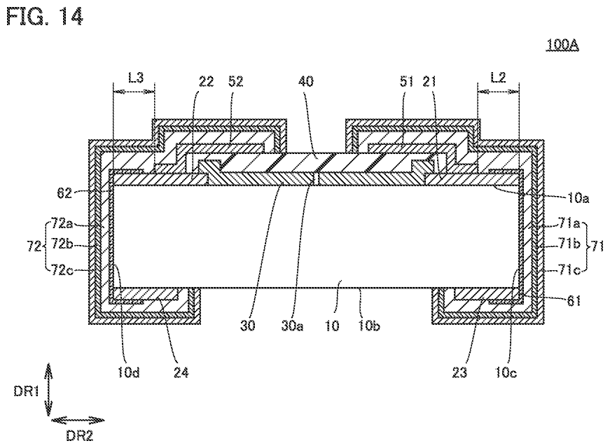

FIG. 14 is a cross-sectional view of chip resistor 100A. As shown in FIG. 14, similarly to chip resistor 100, chip resistor 100A includes insulating substrate 10, first front surface electrode 21 and second front surface electrode 22, first back surface electrode 23 and second back surface electrode 24, resistor body 30, protective film 40, first conductive resin layer 51 and second conductive resin layer 52, first side surface electrode 61 and second side surface electrode 62, and first plating layer 71 and second plating layer 72.

Unlike chip resistor 100, however, in chip resistor 100A, an end of first conductive resin layer 51 on the side close to first side surface 10c is spaced apart from an end of first front surface electrode 21 on the side close to first side surface 10c, and an end of second conductive resin layer 52 on the side close to second side surface 10d is spaced apart from an end of second front surface electrode 22 on the side close to second side surface 10d.

A distance L2 represents the distance in second direction DR2 between the end of first conductive resin layer 51 on the side close to first side surface 10c and the end of first front surface electrode 21 on the side close to first side surface 10c. A distance L3 represents the distance in second direction DR2 between the end of second conductive resin layer 52 on the side close to second side surface 10d and the end of second front surface electrode 22 on the side close to second side surface 10d. Distances L2 and L3 each are preferably 100 μm or more. The width of the portion of first conductive resin layer 51 in second direction DR2 that is located on first front surface electrode 21 is preferably 100 μm or more, and the width of the portion of second conductive resin layer 52 in second direction DR2 that is located on second front surface electrode 22 is preferably 100 μm or more.

### <Effects of Chip Resistor 100A>

In chip resistor 100A, the end of first conductive resin layer 51 on the side close to first side surface 10c is spaced apart from the end of first front surface electrode 21 on the side close to first side surface 10c, and also, the end of second conductive resin layer 52 on the side close to second side surface 10d is spaced apart from the end of second front surface electrode 22 on the side close to second side surface 10d, with the result that a part of first front surface electrode 21 is in direct contact with first plating layer 71 (first layer 71a) and a part of second front surface electrode 22 is in direct contact with second plating layer 72 (first layer 72a). Thus, according to chip resistor 100A, the performance of heat dissipation from resistor body 30 can be further improved.

On the other hand, when distances L2 and L3 become too long, the area of overlapping between first conductive resin layer 51 and first front surface electrode 21 becomes too small, and the area of overlapping between second conductive resin layer 52 and second front surface electrode 22 becomes too small. As a result, heat is not easily transferred from first conductive resin layer 51 to first front surface electrode 21, and heat is not easily transferred from second conductive resin layer 52 to second front surface electrode 22. Thus, each of distances L2 and L3 is set to be 100 μm or more, the width of the portion of first conductive resin layer 51 in second direction DR2 that is located on first front surface electrode 21 is set to be 100 μm or more, and the width of the portion of second conductive resin layer 52 in second direction DR2 that is located on second front surface electrode 22 is set to be 100 μm or more, and thereby, the performance of heat dissipation from resistor body 30 can be further improved.

### Third Embodiment

The following describes a chip resistor according to the third embodiment. The chip resistor according to the third embodiment is referred to as a chip resistor 100B. The following mainly describes differences from chip resistor 100 and the same description will not be repeated.

### <Configuration of Chip Resistor 100B>

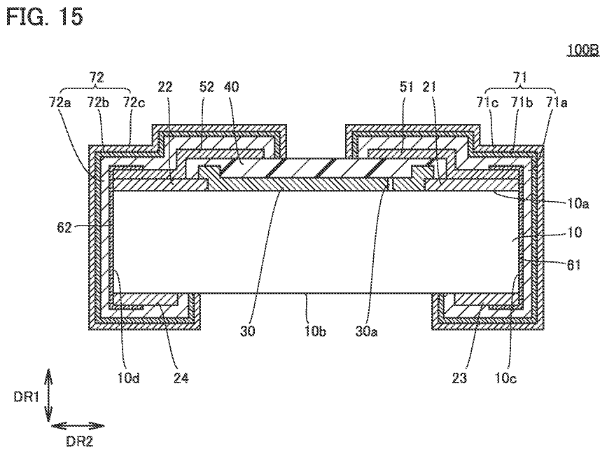

FIG. 15 is a cross-sectional view of chip resistor 100B. As shown in FIG. 15, similarly to chip resistor 100, chip resistor 100B includes insulating substrate 10, first front surface electrode 21 and second front surface electrode 22, first back surface electrode 23 and second back surface electrode 24, resistor body 30, protective film 40, first conductive resin layer 51 and second conductive resin layer 52, first side surface electrode 61 and second side surface electrode 62, and first plating layer 71 and second plating layer 72.

However, in chip resistor 100B, the position of trimming groove 30a in second direction DR2 is displaced toward first side surface 10c from the center position of resistor body 30 in second direction DR2. More specifically, in chip resistor 100B, trimming groove 30a overlaps with first conductive resin layer 51 in a plan view. In this respect, chip resistor 100B is different in configuration from chip resistor 100.

In chip resistor 100B, the position of trimming groove 30a in second direction DR2 may be displaced toward second side surface 10d from the center position of resistor body 30 in second direction DR2. In other words, in chip resistor 100B, trimming groove 30a may overlap with second conductive resin layer 52 in a plan view.

### <Effects of Chip Resistor 100B>

Resistor body 30 is more likely to generate heat in the vicinity of trimming groove 30a. In chip resistor 100B, trimming groove 30a overlaps with first conductive resin layer 51 (second conductive resin layer 52) in a plan view, so that the heat generated in resistor body 30 is easily transferred to first conductive resin layer 51 (second conductive resin layer 52). Thus, according to chip resistor 100B, the heat dissipation performance of resistor body 30 can be further improved.

### (First Test)

In the first test, samples 1 to 7 each were provided as a sample of chip resistor 100. In samples 1 to 7, width W was 3.2 mm. In samples 1 to 7, distance L1 was varied. In other words, in samples 1 to 7, the value obtained by dividing distance L1 by width W was varied. The first test was performed in the state in which each sample was mounted such that its first main surface 10a faced circuit board 200.

The heat dissipation performance of each sample was evaluated based on the rate of change in electrical resistance value obtained when a current exceeding the rated current flowed through each sample. More specifically, five samples were prepared for each of samples 1 to 7 for evaluations, in which the result was evaluated as A when the change in electrical resistivity was less than 1 percent in all of the five samples, evaluated as B when the change in electrical resistivity was equal to or greater than 1 percent and less than 2 percent in some of the five samples and when the change in electrical resistivity was less than 1 percent in the remainder of the five samples, and evaluated as C when the change in electrical resistivity was equal to or greater than 2 percent in some of the five samples.

TABLE 1

| | | | | Scaling Factor of Current Flowing Through Sample | | | | | | | |
|---|---|---|---|---|---|---|---|---|---|---|---|
| | Distance L1 | Width W | Distance L1/ | with respect to Rated Current | | | | | | | |
| Sample | (mm) | (mm) | Width W | ×2.5 | ×3.0 | ×3.1 | ×3.2 | ×3.3 | ×3.4 | 3.5 | 3.6 |
| 1 | 1.3 | 3.2 | 0.4063 | w | A | A | B | C | — | — | — |
| 2 | 0.8 | 3.2 | 0.2500 | A | A | A | A | B | C | — | — |
| 3 | 0.7 | 3.2 | 0.2188 | A | A | A | A | A | C | — | — |
| 4 | 0.6 | 3.2 | 0.1875 | A | A | A | A | A | C | — | — |
| 5 | 0.5 | 3.2 | 0.1563 | A | A | A | A | A | A | — | — |
| 6 | 0.4 | 3.2 | 0.1250 | A | A | A | A | A | C | — | — |
| 7 | 0.3 | 3.2 | 0.0938 | A | A | A | A | A | A | A | C |

As shown in Table 1, in sample 1, the heat dissipation performance was evaluated as A when a current equal to or less than 3.1 times the rated current flowed, whereas the heat dissipation performance was evaluated as B or less when a current equal to or greater than 3.2 times the rated current flowed. In sample 2, the heat dissipation performance was evaluated as A when a current equal to or less than 3.2 times the rated current flowed, whereas the heat dissipation performance was evaluated as B or less when a current equal to or greater than 3.3 times the rated current flowed. In samples 3 to 7, even when a current equal to 3.3 times the rated current flowed, the heat dissipation performance was evaluated as A.

In samples 1 and 2, the value obtained by dividing distance L1 by width W was not within the range of 0.0938 or more and 0.2188 or less (distance L1 was 300 μm or more and 700 μm or less). In samples 3 to 7, the value obtained by dividing distance L1 by width W was within the range of 0.0938 or more and 0.2188 or less (distance L1 was 300 μm or more and 700 μm or less). From the above-mentioned comparison, it was experimentally revealed that the heat dissipation performance of resistor body 30 was improved when the value obtained by dividing distance L1 by width W was set to be 0.0938 or more and 0.2188 or less (distance L1 was set to be 300 μm or more and 700 μm or less).

### (Second Test)

In the second test, a sample 8 was provided as a sample of chip resistor 100 and samples 9 to 12 each were provided as a sample of chip resistor 100B. In samples 8 to 12, width W was 3.2 mm. In samples 8 to 12, distance L1 was 0.4 mm. The second test was performed in the state in which each sample was mounted such that its first main surface 10a faced circuit board 200.

In sample 8, the end of first conductive resin layer 51 on the side close to first side surface 10c was not spaced apart from the end of first front surface electrode 21 on the side close to first side surface 10c, and the end of second conductive resin layer 52 on the side close to second side surface 10d was not spaced apart from the end of second front surface electrode 22 on the side close to second side surface 10d. In samples 9 to 12, distances L2 and L3 each were varied.

The heat dissipation performance of each of samples 8 to 12 was evaluated based on the rate of change in electrical resistance value obtained when a current exceeding the rated current flowed through each sample. When a current equal to or less than 3.3 times the rated current flowed, the rate of change in electrical resistance value was less than 1 percent in all of the prepared five samples 8. When a current equal to or greater than 3.4 times the rated current flowed, the rate of change in electrical resistance value was greater than 1 percent in at least some of the prepared five samples 8.

When a current equal to or less than 3.4 times the rated current flowed, the rate of change in electrical resistance value was less than 1 percent in all of the prepared five samples 9 and all of the prepared five samples 10. When a current equal to or greater than 3.5 times the rated current flowed, the rate of change in electrical resistance value was greater than 1 percent in at least some of the prepared five samples 9 and at least some of the prepared five samples 10.

When a current equal to or less than 3.3 times the rated current flowed, the rate of change in electrical resistance value was less than 1 percent in all of the prepared five samples 11 and all of the prepared five samples 12. When a current equal to or greater than 3.4 times the rated current flowed, the rate of change in electrical resistance value was greater than 1 percent in at least some of the prepared five samples 10 and at least some of the prepared five samples 12.

A condition A specifies that distances L2 and L3 each are 100 μm or more. A condition B specifies that the width of the portion of first conductive resin layer 51 in second direction DR2 that is located on first front surface electrode 21 is 100 μm or more, and the width of the portion of second conductive resin layer 52 in second direction DR2 that is located on second front surface electrode 22 is 100 μm or more. In samples 8, 11, and 12, conditions A and B were not satisfied. On the other hand, in samples 9 and 10, conditions A and B were satisfied. From the above-mentioned comparison, it was experimentally revealed that the heat dissipation performance of resistor body 30 was improved when conditions A and B were satisfied.

### (Third Test)

In the third test, samples 13 and 14 each were provided as a sample of chip resistor 100B. In sample 13, trimming groove 30a did not overlap with any of first conductive resin layer 51 and second conductive resin layer 52 in a plan view. In sample 14, trimming groove 30a overlapped with first conductive resin layer 51 in a plan view. The heat dissipation performance of each of samples 13 and 14 was evaluated based on the rate of change in the electrical resistance value obtained when a current exceeding the rated current flowed through each sample. The third test was performed in the state in which each sample was mounted such that its first main surface 10a faced circuit board 200.

When a current equal to or less than 3.7 times the rated current flowed, the rate of change in electrical resistance value was less than 1 percent in all of the prepared five samples 13. When a current equal to or greater than 3.8 times the rated current flowed, the rate of change in electrical resistance value was greater than 1 percent in at least some of the prepared five samples 13.

On the other hand, when a current equal to or less than 4.3 times the rated current flowed, the rate of change in electrical resistance value was less than 1 percent in all of the prepared five samples 14. When a current equal to or greater than 4.4 times the rated current flowed, the rate of change in electrical resistance value was greater than 1 percent in at least some of the prepared five samples 14. From the above-mentioned comparison, it was experimentally revealed that the heat dissipation performance of resistor body 30 was improved when trimming groove 30a overlapped with first conductive resin layer 51 (second conductive resin layer 52) in a plan view.

### Fourth Embodiment

The following describes a chip resistor according to the fourth embodiment. The chip resistor according to the fourth embodiment is referred to as a chip resistor 100C. The following mainly describes differences from chip resistor 100 and the same description will not be repeated.

### <Configuration of Chip Resistor 100C>

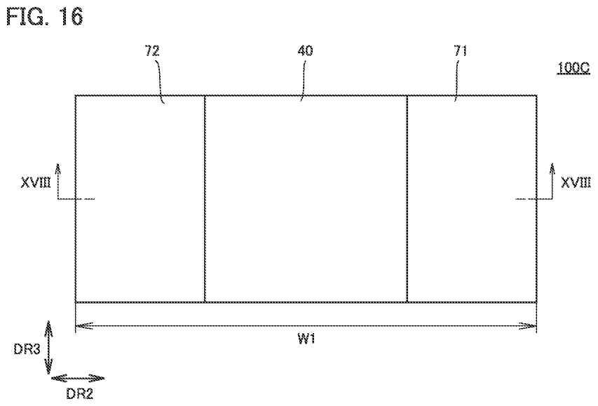

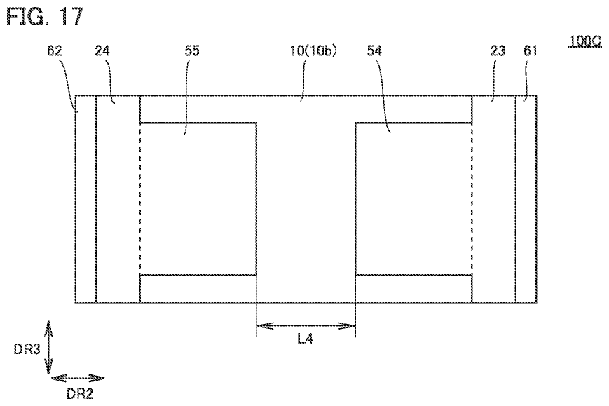

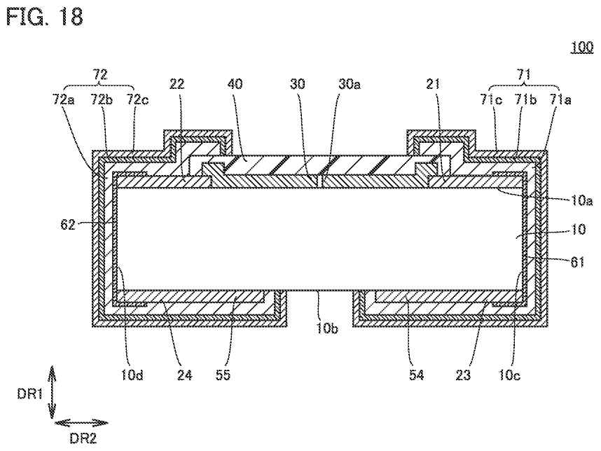

FIG. 16 is a top view of chip resistor 100C. FIG. 17 is a bottom view of chip resistor 100C. Note that FIG. 17 does not show first plating layer 71 and second plating layer 72. FIG. 18 is a cross-sectional view taken along a line XVIII-XVIII in FIG. 16. As shown in FIGS. 16, 17, and 18, chip resistor 100C includes insulating substrate 10, first front surface electrode 21 and second front surface electrode 22, first back surface electrode 23 and second back surface electrode 24, resistor body 30, protective film 40, first side surface electrode 61 and second side surface electrode 62, and first plating layer 71 and second plating layer 72. In this respect, chip resistor 100C has the same configuration as that of chip resistor 100.

Chip resistor 100C does not include first conductive resin layer 51 and second conductive resin layer 52, but further includes a first heat dissipation film 54 and a second heat dissipation film 55.

First heat dissipation film 54 and second heat dissipation film 55 each are made of an electrically conductive material. First heat dissipation film 54 and second heat dissipation film 55 each are made, for example, of burned metal particles. The metal particles are, for example, silver particles.

First heat dissipation film 54 and second heat dissipation film 55 are disposed on second main surface 10b. More specifically, first heat dissipation film 54 extends on second main surface 10b in second direction DR2 from first back surface electrode 23 toward second back surface electrode 24. Second heat dissipation film 55 extends on second main surface 10b in second direction DR2 from second back surface electrode 24 toward first back surface electrode 23. First heat dissipation film 54 and second heat dissipation film 55 are spaced apart from each other in second direction DR2. In other words, second main surface 10b is exposed from between first heat dissipation film 54 and second heat dissipation film 55.

The width of first heat dissipation film 54 in third direction DR3 is preferably smaller than the width of first back surface electrode 23 in third direction DR3. The width of second heat dissipation film 55 in third direction DR3 is preferably smaller than the width of second back surface electrode 24 in third direction DR3.

A distance L4 represents the distance in second direction DR2 between first heat dissipation film 54 and second heat dissipation film 55 (the distance in second direction DR2 between the end of first heat dissipation film 54 on the side close to second back surface electrode 24 and the end of second heat dissipation film 55 on the side close to first back surface electrode 23). A width W1 represents the width of chip resistor 100C in second direction DR2. The value obtained by dividing distance L4 by width W1 is preferably 0.4 or less. Preferably, the sum of the width of first back surface electrode 23 in second direction DR2 and the width of first heat dissipation film 54 in second direction DR2 is equal to or greater than 0.3 times width W1, and the sum of the width of second back surface electrode 24 in second direction DR2 and the width of second heat dissipation film 55 in second direction DR2 is equal to or greater than 0.3 times width W1. Distance L4 is preferably 300 μm or more.

In chip resistor 100C, trimming groove 30a does not overlap with each of first heat dissipation film 54 and second heat dissipation film 55 in a plan view. In chip resistor 100C, trimming groove 30a may overlap with one of first heat dissipation film 54 and second heat dissipation film 55 in a plan view. In these respects, chip resistor 100C has the same configuration as that of chip resistor 100.

### <Method of Manufacturing Chip Resistor 100C>

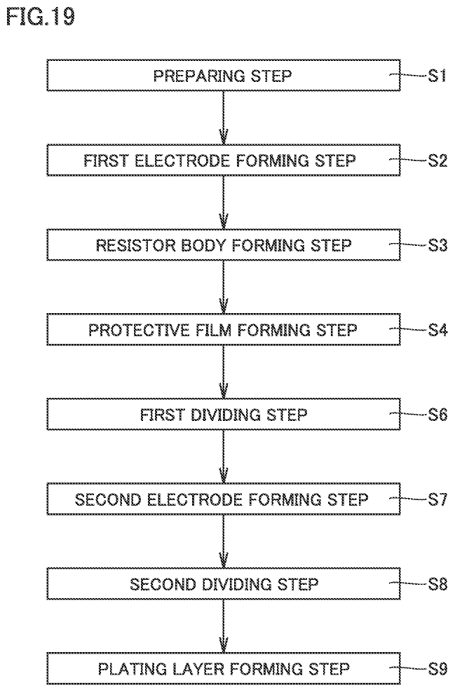

FIG. 19 is a process diagram showing a method of manufacturing chip resistor 100C. As shown in FIG. 19, the method of manufacturing chip resistor 100C includes preparing step S1, first electrode forming step S2, resistor body forming step S3, protective film forming step S4, first dividing step S6, second electrode forming step S7, second dividing step S8, and plating layer forming step S9. In this respect, the method of manufacturing chip resistor 100C is the same as the method of manufacturing chip resistor 100.

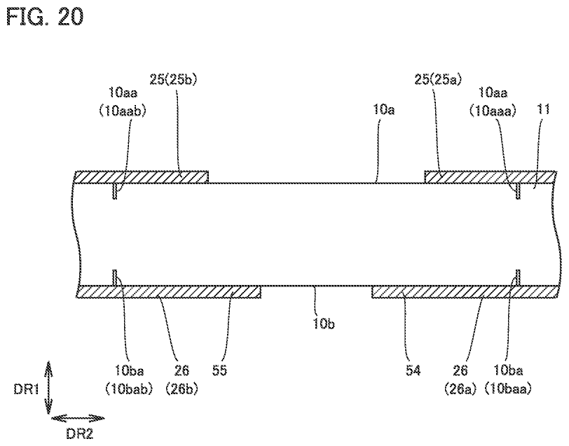

The method of manufacturing chip resistor 100C does not include conductive resin layer forming step S5. FIG. 20 is a cross-sectional view for illustrating first electrode forming step S2 in the method of manufacturing chip resistor 100C. As shown in FIG. 20, in first electrode forming step S2 in the method of manufacturing chip resistor 100C, first heat dissipation film 54 and second heat dissipation film 55 are further formed. First heat dissipation film 54 is formed on second main surface 10b to extend from front surface electrode 25a toward front surface electrode 25b, and second heat dissipation film 55 is formed on second main surface 10b to extend from front surface electrode 25b toward front surface electrode 25a. First heat dissipation film 54 and second heat dissipation film 55 are formed by applying a paste containing metal particles such as silver particles and then burning the applied paste. In these respects, the method of manufacturing chip resistor 100C is different from the method of manufacturing chip resistor 100.

### <Effects of Chip Resistor 100C>

In chip resistor 100C, part of the heat generated in resistor body 30 is transferred to the second main surface 10b side through insulating substrate 10. In chip resistor 100C, first heat dissipation film 54 and second heat dissipation film 55 are disposed on second main surface 10b, and thereby, the heat transferred to the second main surface 10b side through insulating substrate 10 is easily dissipated from first heat dissipation film 54 and second heat dissipation film 55. In this way, according to chip resistor 100C, the heat dissipation performance of resistor body 30 is improved.

As the value obtained by dividing distance L4 by width W1 becomes smaller, the areas of second main surface 10b that are covered by first heat dissipation film 54 and second heat dissipation film 55 become larger. Accordingly, the heat transferred to the second main surface 10b side through insulating substrate 10 is easily dissipated from first heat dissipation film 54 and second heat dissipation film 55. On the other hand, if distance L4 is too small, first heat dissipation film 54 and second heat dissipation film 55 may come into contact with each other due to manufacturing errors or the like, which may cause a short circuit between first back surface electrode 23 and second back surface electrode 24. Therefore, when the value obtained by dividing distance L4 by width W1 is 0.4 or less and distance L4 is 300 μm or more, the heat dissipation performance of resistor body 30 can be improved while suppressing a short circuit between first back surface electrode 23 and second back surface electrode 24.

### Fifth Embodiment

The following describes a chip resistor according to the fifth embodiment. The chip resistor according to the fifth embodiment is referred to as a chip resistor 100D. The following mainly describes differences from chip resistor 100C and the same description will not be repeated.

### <Configuration of Chip Resistor 100D>

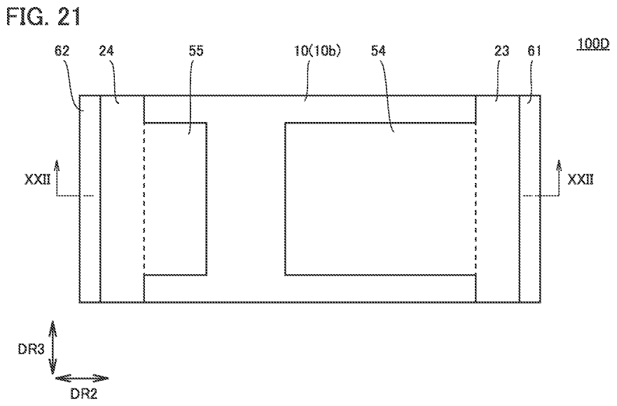

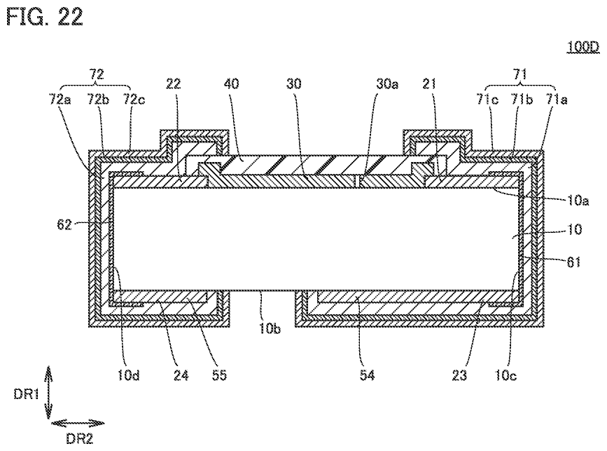

FIG. 21 is a bottom view of chip resistor 100D. Note that FIG. 21 does not show first plating layer 71 and second plating layer 72. FIG. 22 is a cross-sectional view taken along a line XXII-XXII in FIG. 21. As shown in FIGS. 21 and 22, chip resistor 100D includes insulating substrate 10, first front surface electrode 21 and second front surface electrode 22, first back surface electrode 23 and second back surface electrode 24, first heat dissipation film 54 and second heat dissipation film 55, resistor body 30, protective film 40, first side surface electrode 61 and second side surface electrode 62, and first plating layer 71 and second plating layer 72. In this respect, chip resistor 100D has the same configuration as that of chip resistor 100C.

In chip resistor 100D, the width of first heat dissipation film 54 in second direction DR2 is different from the width of second heat dissipation film 55 in second direction DR2. More specifically, in chip resistor 100D, the width of first heat dissipation film 54 in second direction DR2 is larger than the width of second heat dissipation film 55 in second direction DR2, and the end of first heat dissipation film 54 on the side close to second heat dissipation film 55 is located closer to second side surface 10d than the center of second main surface 10b in second direction DR2. In chip resistor 100D, trimming groove 30a overlaps with first heat dissipation film 54 in a plan view. In these respects, chip resistor 100D is different in configuration from chip resistor 100C.

In chip resistor 100D, the width of second heat dissipation film 55 in second direction DR2 may be larger than the width of first heat dissipation film 54 in second direction DR2, and the end of second heat dissipation film 55 on the side close to first heat dissipation film 54 may be located closer to first side surface 10c than the center of second main surface 10b in second direction DR2. In chip resistor 100D, trimming groove 30a may overlap with second heat dissipation film 55 in a plan view.

### <Effects of Chip Resistor 100D>

Resistor body 30 generates a large amount of heat in the vicinity of trimming groove 30a. In chip resistor 100D, trimming groove 30a is located to overlap with first heat dissipation film 54 (second heat dissipation film 55) in a plan view, so that the heat generated in the vicinity of trimming groove 30a is easily dissipated from first heat dissipation film 54 (second heat dissipation film 55) through insulating substrate 10. In this way, according to chip resistor 100D, the heat dissipation performance of resistor body 30 is further improved.

### Sixth Embodiment

The following describes a chip resistor according to the sixth embodiment. The chip resistor according to the sixth embodiment is referred to as a chip resistor 100E. The following mainly describes differences from chip resistor 100C and the same description will not be repeated.

### <Configuration of Chip Resistor 100E>

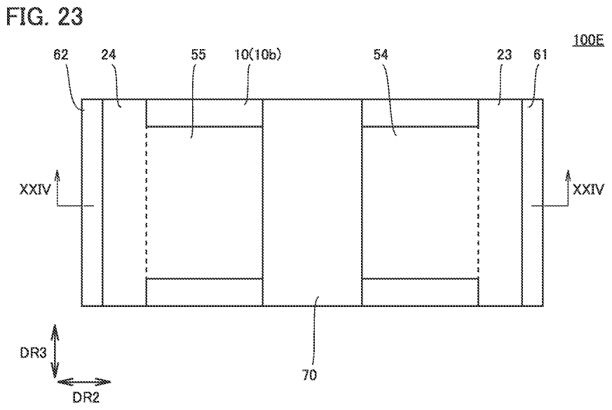

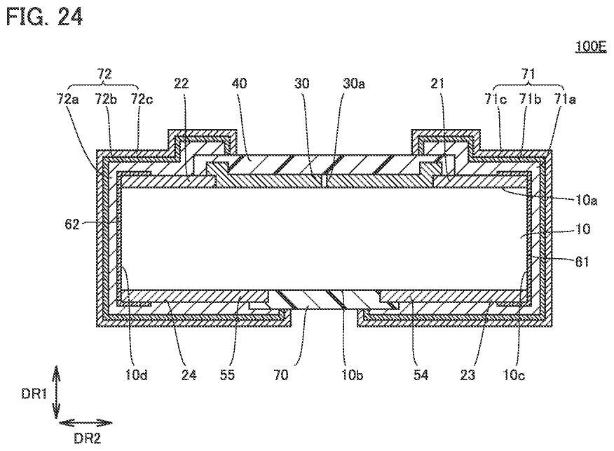

FIG. 23 is a bottom view of chip resistor 100E. Note that FIG. 23 does not show first plating layer 71 and second plating layer 72. FIG. 24 is a cross-sectional view taken along a line XXIV-XXIV in FIG. 23. As shown in FIGS. 23 and 24, chip resistor 100E includes insulating substrate 10, first front surface electrode 21 and second front surface electrode 22, first back surface electrode 23 and second back surface electrode 24, first heat dissipation film 54 and second heat dissipation film 55, resistor body 30, protective film 40, first side surface electrode 61 and second side surface electrode 62, and first plating layer 71 and second plating layer 72. In this respect, chip resistor 100E has the same configuration as that of chip resistor 100C.

Chip resistor 100E further includes a third heat dissipation film 70. Third heat dissipation film 70 is disposed on second main surface 10b between first heat dissipation film 54 and second heat dissipation film 55. Both ends of third heat dissipation film 70 in second direction DR2 may be respectively disposed on first heat dissipation film 54 and second heat dissipation film 55.

Third heat dissipation film 70 is made of an electrically insulating material. Third heat dissipation film 70 is made of a material having high thermal conductivity. Third heat dissipation film 70 is higher in thermal conductivity, for example, than protective film 40. Third heat dissipation film 70 is made, for example, of a thermal conductive adhesive (TCA). More specifically, third heat dissipation film 70 contains, for example, a resin material and particles that are made of an electrically insulating material. The above-mentioned resin material is, for example, an epoxy resin or a phenolic resin, and the above-mentioned particles are alumina particles. In these respects, chip resistor 100E is different in configuration from chip resistor 100C. Note that third heat dissipation film 70 is formed, for example, in protective film forming step S4.

### <Effects of Chip Resistor 100E>

In chip resistor 100E, third heat dissipation film 70 higher in thermal conductivity than protective film 40 is disposed on second main surface 10b, so that the heat transferred to the second main surface 10b side through insulating substrate 10 is further easily dissipated. In this way, according to chip resistor 100E, the heat dissipation performance of resistor body 30 is further improved.

### (Supplementary Notes)

The fourth to sixth embodiments include the following configurations.

### <Supplementary Note 1>

A chip resistor including:
an insulating substrate having a first main surface, a second main surface, a first side surface, and a second side surface, the first main surface and the second main surface each being an end surface in a thickness direction of the chip resistor, and the first side surface and the second side surface each being an end surface in a longitudinal direction of the chip resistor;
a resistor body disposed on the first main surface;
a first back surface electrode disposed on an end portion of the second main surface on a side close to the first side surface;
a second back surface electrode disposed on an end portion of the second main surface on a side close to the second side surface;
a first heat dissipation film disposed on the second main surface and extending in the longitudinal direction from the first back surface electrode toward the second back surface electrode; and
a second heat dissipation film disposed on the second main surface and extending in the longitudinal direction from the second back surface electrode toward the first back surface electrode, wherein
the first heat dissipation film and the second heat dissipation film each are made of an electrically conductive material and are spaced apart from each other in the longitudinal direction.

### <Supplementary Note 2>

The chip resistor according to Supplementary Note 1, wherein
a width of the first heat dissipation film in a width direction of the chip resistor is smaller than a width of the first back surface electrode in the width direction, and
a width of the second heat dissipation film in the width direction is smaller than a width of the second back surface electrode in the width direction.

### <Supplementary Note 3>

The chip resistor according to Supplementary Note 1 or 2, wherein
a value obtained by dividing a distance between the first heat dissipation film and the second heat dissipation film in the longitudinal direction by a width of the chip resistor in the longitudinal direction is 0.4 or less, and
the distance between the first heat dissipation film and the second heat dissipation film in the longitudinal direction is 300 μm or more.

### <Supplementary Note 4>

The chip resistor according to any one of Supplementary Notes 1 to 3, wherein a width of the first heat dissipation film in the longitudinal direction is different from a width in a longitudinal direction of the second heat dissipation film in the longitudinal direction.

### <Supplementary Note 5>

The chip resistor according to Supplementary Note 4, wherein an end of the first heat dissipation film on a side close to the second heat dissipation film is located closer to the second side surface than a center position of the second main surface in the longitudinal direction.

### <Supplementary Note 6>

The chip resistor according to any one of Supplementary Notes 1 to 5, wherein
the resistor body is provided with a trimming groove, and
one of the first heat dissipation film and the second heat dissipation film overlaps with the trimming groove in a plan view.

### <Supplementary Note 7>

The chip resistor according to any one of Supplementary Notes 1 to 6, wherein the first heat dissipation film and the second heat dissipation film each are made of silver.

### <Supplementary Note 8>

The chip resistor according to any one of Supplementary Notes 1 to 7, further including a third heat dissipation film made of an electrically insulating material, wherein the third heat dissipation film is disposed on the second main surface between the first heat dissipation film and the second heat dissipation film.

### <Supplementary Note 9>

The chip resistor according to Supplementary Note 8, wherein the third heat dissipation film is made of an adhesive containing an insulating filler.

### Seventh Embodiment

The following describes a chip resistor according to the seventh embodiment. The chip resistor according to the seventh embodiment is referred to as a chip resistor 100F. The following mainly describes differences from chip resistor 100 and the same description will not be repeated.

### <Configuration of Chip Resistor 100F>

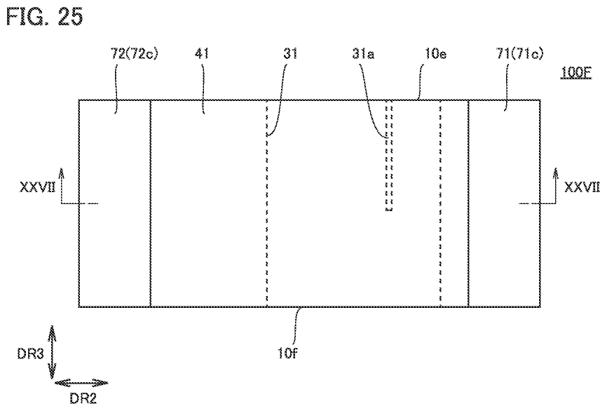

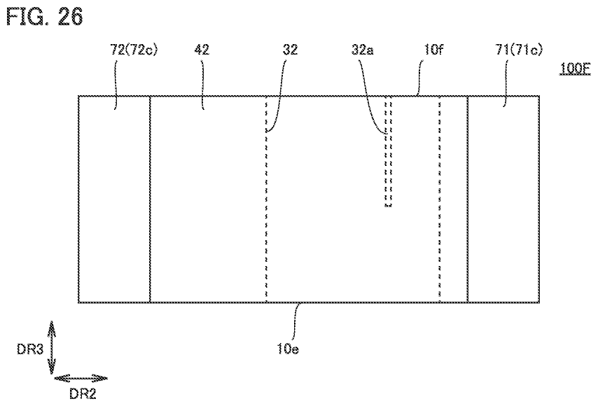

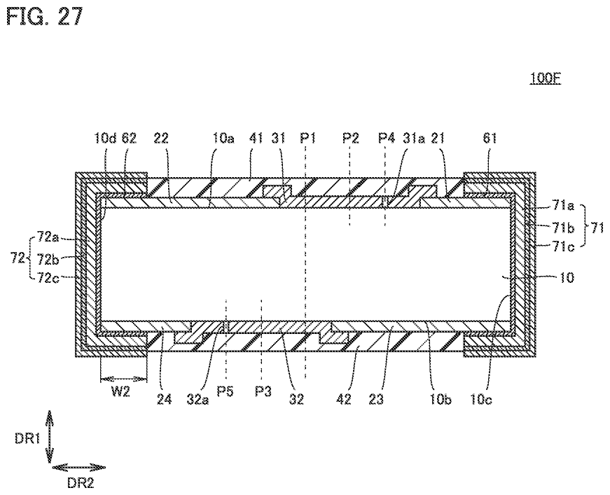

FIG. 25 is a top view of chip resistor 100F. FIG. 26 is a bottom view of chip resistor 100F. FIG. 27 is a cross-sectional view taken along a line XXVII-XXVII in FIG. 25. As shown in FIGS. 25, 26, and 27, chip resistor 100F includes insulating substrate 10, first front surface electrode 21, second front surface electrode 22, first back surface electrode 23, second back surface electrode 24, first side surface electrode 61, second side surface electrode 62, first plating layer 71, and second plating layer 72. In this respect, chip resistor 100F has the same configuration as that of chip resistor 100.

Chip resistor 100F includes a first resistor body 31 and a second resistor body 32 in place of resistor body 30. Chip resistor 100F includes a first protective film 41 and a second protective film 42 in place of protective film 40. Chip resistor 100F does not include first conductive resin layer 51 and second conductive resin layer 52.

In chip resistor 100F, insulating substrate 10 further includes a third side surface 10e and a fourth side surface 10f. Third side surface 10e and fourth side surface 10f are end surfaces of insulating substrate 10 in third direction DR3. Fourth side surface 10f is a surface opposite to third side surface 10e. In chip resistor 100F, the center position of insulating substrate 10 in second direction DR2 is referred to as a first position P1.

In chip resistor 100F, the metal particles contained in first front surface electrode 21, second front surface electrode 22, first back surface electrode 23, and second back surface electrode 24 are preferably copper (Cu) particles. The copper particles may be mixed with nickel (Ni) particles. The metal particles may be silver (Ag) particles, and the silver particles may be mixed with palladium (Pd) particles.

In chip resistor 100F, first front surface electrode 21 extends in second direction DR2 from an end portion of first main surface 10a on the side close to first side surface 10c toward first resistor body 31, and second front surface electrode 22 extends in second direction DR2 from an end portion of first main surface 10a on the side close to second side surface 10d toward first resistor body 31. In chip resistor 100F, the width of first front surface electrode 21 in second direction DR2 is smaller than the width of second front surface electrode 22 in the second direction.

In chip resistor 100F, first back surface electrode 23 extends in second direction DR2 from an end portion of second main surface 10b on the side close to first side surface 10c toward second resistor body 32, and second back surface electrode 24 extends in second direction DR2 from an end portion of second main surface 10b on the side close to second side surface 10d toward second resistor body 32. The width of first back surface electrode 23 in second direction DR2 is larger than the width of second back surface electrode 24 in the second direction.

First resistor body 31 and second resistor body 32 each are made of a conductive material. First resistor body 31 and second resistor body 32 each are formed, for example, by burning a paste containing metal particles. The metal particles are, for example, silver-palladium (Pd) alloy particles.

First resistor body 31 is disposed on first main surface 10a between first front surface electrode 21 and second front surface electrode 22. First resistor body 31 is disposed also on an end portion of first front surface electrode 21 on the side close to second side surface 10d and on an end portion of second front surface electrode 22 on the side close to first side surface 10c. First resistor body 31 is electrically connected to first front surface electrode 21 and second front surface electrode 22.

The center position of first resistor body 31 in second direction DR2 is referred to as a second position P2. Second position P2 is displaced from first position P1 toward first side surface 10c in second direction DR2.

Second resistor body 32 is disposed on second main surface 10b between first back surface electrode 23 and second back surface electrode 24. Second resistor body 32 is disposed also on an end portion of first back surface electrode 23 on the side close to second side surface 10d and on an end portion of second back surface electrode 24 on the side close to first side surface 10c. Second resistor body 32 is electrically connected to first back surface electrode 23 and second back surface electrode 24.

The center position of second resistor body 32 in second direction DR2 is referred to as a third position P3. Third position P3 is displaced from first position P1 toward second side surface 10d in second direction DR2. In other words, third position P3 is displaced from first position P1 in second direction DR2 to the side opposite to second position P2.

First resistor body 31 is provided with a first trimming groove 31a. First trimming groove 31a is provided for adjusting the electrical resistance value of first resistor body 31. First trimming groove 31a penetrates first resistor body 31 in first direction DR1. First trimming groove 31a extends in third direction DR3. First trimming groove 31a extends, for example, from third side surface 10e toward fourth side surface 10f (see FIG. 25). An end of first trimming groove 31a on the side close to third side surface 10e reaches the end of first resistor body 31 on the side close to third side surface 10e. First trimming groove 31a is formed, for example, by partially removing first resistor body 31 by irradiation with a laser beam.

Second resistor body 32 is provided with a second trimming groove 32a. Second trimming groove 32a is formed for adjusting the electrical resistance value of second resistor body 32. Second trimming groove 32a penetrates second resistor body 32 in first direction DR1. Second trimming groove 32a extends in third direction DR3. Second trimming groove 32a extends, for example, from fourth side surface 10f toward third side surface 10e (see FIG. 26). An end of second trimming groove 32a on the side close to fourth side surface 10f reaches the end of second resistor body 32 on the side close to fourth side surface 10f. In other words, first trimming groove 31a and second trimming groove 32a are formed in an alternating manner. Second trimming groove 32a is formed, for example, by partially removing second resistor body 32 by irradiation with a laser beam.

The position of first trimming groove 31a in second direction DR2 is referred to as a fourth position P4. The position of second trimming groove 32a in second direction DR2 is referred to as a fifth position P5. Fourth position P4 is displaced from second position P2 toward first side surface 10c in second direction DR2. Fifth position P5 is displaced from third position P3 toward second side surface 10d in second direction DR2. Although not shown, fourth position P4 and fifth position P5 may coincide with second position P2 and third position P3, respectively, in second direction DR2.

First protective film 41 and second protective film 42 each are made of an insulating material. First protective film 41 and second protective film 42 each are made of a resin material such as an epoxy resin or a phenol resin.

First protective film 41 is disposed on first resistor body 31. First protective film 41 is disposed also on first front surface electrode 21 and second front surface electrode 22. However, an end of first protective film 41 on the side close to first side surface 10c is spaced apart from the end of first front surface electrode 21 on the side close to first side surface 10c while an end of first protective film 41 on the side close to second side surface 10d is spaced apart from the end of first front surface electrode 21 on the side close to first side surface 10d. Second protective film 42 is disposed on second resistor body 32. Second protective film 42 is disposed also on first back surface electrode 23 and second back surface electrode 24. However, an end of second protective film 42 on the side close to first side surface 10c is spaced apart from the end of first back surface electrode 23 on the side close to first side surface 10c while an end of second protective film 42 on the side close to second side surface 10d is spaced apart from the end of first back surface electrode 23 on the side close to second side surface 10d.

A width W2 represents each of: the width of first plating layer 71 in second direction DR2 that is located on first back surface electrode 23 with first side surface electrode 61 interposed therebetween; and the width of second plating layer 72 in second direction DR2 that is located on second back surface electrode 24 with second side surface electrode 62 interposed therebetween. Width W2 is preferably 100 μm or more. Width W2 is more preferably 200 μm or more. In these respects, chip resistor 100F is different in configuration from chip resistor 100.

### <Method of Manufacturing Chip Resistor 100F>

The method of manufacturing chip resistor 100F includes preparing step S1, first electrode forming step S2, resistor body forming step S3, protective film forming step S4, first dividing step S6, second electrode forming step S7, second dividing step S8, and plating layer forming step S9. In this respect, the method of manufacturing chip resistor 100F is the same as the method of manufacturing chip resistor 100.

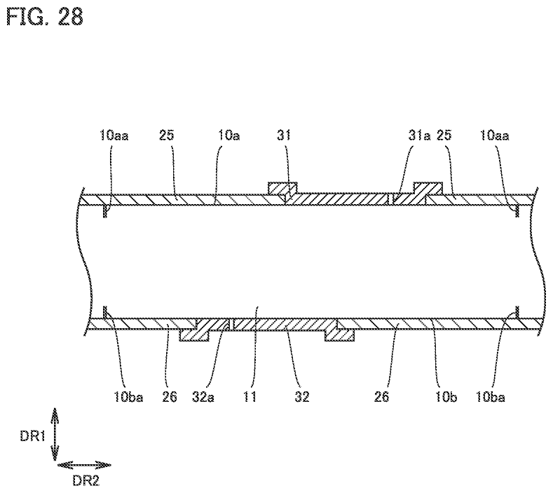

The method of manufacturing chip resistor 100C does not include conductive resin layer forming step S5. In the method of manufacturing chip resistor 100F, the order in which resistor body forming step S3 is performed may be reversed from the order in which first electrode forming step S2 is performed. FIG. 28 is a cross-sectional view for illustrating resistor body forming step S3 in the method of manufacturing chip resistor 100F. As shown in FIG. 28, in resistor body forming step S3 in the method of manufacturing chip resistor 100F, first resistor body 31 and second resistor body 32 are formed in place of resistor body 30.

First resistor body 31 is formed on a portion of first main surface 10a that is located between two adjacent front surface electrodes 25 such that both ends of first resistor body 31 in second direction DR2 are located on the two respective front surface electrodes 25 adjacent to each other. Second resistor body 32 is formed on a portion of second main surface 10b that is located between two adjacent back surface electrodes 26 such that both ends of second resistor body 32 in second direction DR2 are located on the two respective back surface electrodes 26 adjacent to each other. First resistor body 31 and second resistor body 32 are formed by applying a paste containing metal particles such as silver-palladium alloy particles and then burning the applied paste.

In resistor body forming step S3 in the method of manufacturing chip resistor 100F, after first resistor body 31 and second resistor body 32 are formed, for example, first trimming groove 31a and second trimming groove 32a are formed by irradiation with a laser beam to thereby adjust the electrical resistance values of first resistor body 31 and second resistor body 32.

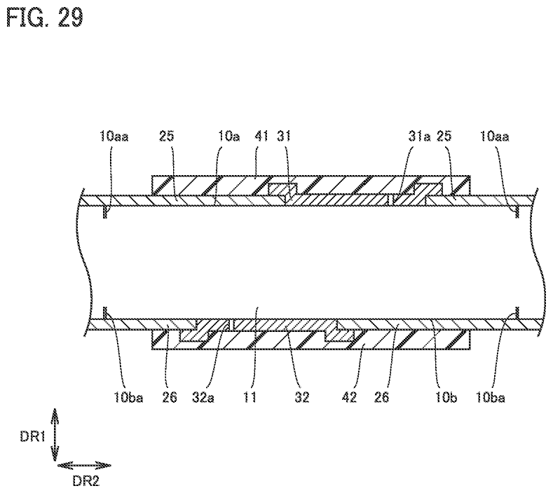

FIG. 29 is a cross-sectional view for illustrating protective film forming step S4 in the method of manufacturing chip resistor 100F. As shown in FIG. 29, in protective film forming step S4, first protective film 41 and second protective film 42 are formed in place of protective film 40. First protective film 41 is formed on first resistor body 31 such that both ends of first protective film 41 in second direction DR2 are located on the two respective front surface electrodes 25 adjacent to each other. Second protective film 42 is formed on second resistor body 32 such that both ends of second protective film 42 in second direction DR2 are located on the two respective back surface electrodes 26 adjacent to each other. First protective film 41 and second protective film 42 are formed by applying an uncured resin material and then heating and curing the applied resin material. In these respects, the method of manufacturing chip resistor 100F is different from the method of manufacturing chip resistor 100.

### <Effects of Chip Resistor 100F>

In chip resistor 100F, first resistor body 31 generates a large amount of heat in the vicinity of second position P2. In chip resistor 100F, second position P2 is displaced from first position P1 toward first side surface 10c in second direction DR2, and the distance between bonding member 240 and the portion in which first resistor body 31 generates a large amount of heat becomes small, and thus, the heat generated by first resistor body 31 is easily dissipated from circuit board 200 through bonding member 240. In this way, in chip resistor 100F, the heat dissipation performance of first resistor body 31 is improved.

In chip resistor 100F, second resistor body 32 generates a large amount of heat in the vicinity of third position P3. In chip resistor 100F, third position P3 is displaced from first position P1 toward second side surface 10d in second direction DR2, and the distance between bonding member 250 and the portion in which second resistor body 32 generates a large amount of heat becomes small, and thus, the heat generated by second resistor body 32 is easily dissipated from circuit board 200 through bonding member 250.

In this way, in chip resistor 100F, the heat dissipation performance of second resistor body 32 is improved. In particular, in chip resistor 100F, since third position P3 is displaced from first position P1 to the side opposite to second position P2, the path of heat dissipation from first resistor body 31 is separated from the path of heat dissipation from second resistor body 32, so that the heat dissipation performance is further improved.

First resistor body 31 generates a large amount of heat also in the vicinity of fourth position P4. Second resistor body 32 generates a large amount of heat also in the vicinity of fifth position P5. In chip resistor 100F, fourth position P4 is displaced from second position P2 toward first side surface 10c and fifth position P5 is displaced from third position P3 toward second side surface 10d, which leads to a smaller distance between bonding member 240 and the portion in which first resistor body 31 generates a large amount of heat, and also leads to a smaller distance between bonding member 250 and the portion in which second resistor body 32 generates a large amount of heat. As a result, the heat dissipation performance is further improved in chip resistor 100F.

When the deviation of second position P2 from first position P1 becomes larger and the deviation of third position P3 from first position P1 becomes larger, width W2 becomes smaller. When width W2 is less than 100 μm, the width of first plating layer 71 bonded by bonding member 240 becomes smaller, so that the width of the path of heat transfer from chip resistor 100F to circuit board 200 becomes smaller.

When width W2 is 100 μm or more (200 μm or more), the width of first plating layer 71 bonded by bonding member 240 becomes larger, and thus, the width of the path of heat transfer from chip resistor 100F to circuit board 200 can be ensured, so that the heat dissipation performance of chip resistor 100F can be further improved. In this case, the reliability of bonding between chip resistor 100F and circuit board 200 can also be improved.

### Eighth Embodiment

The following describes a chip resistor according to the eighth embodiment. The chip resistor according to the eighth embodiment is referred to as a chip resistor 100G. The following mainly describes differences from chip resistor 100F and the same description will not be repeated.

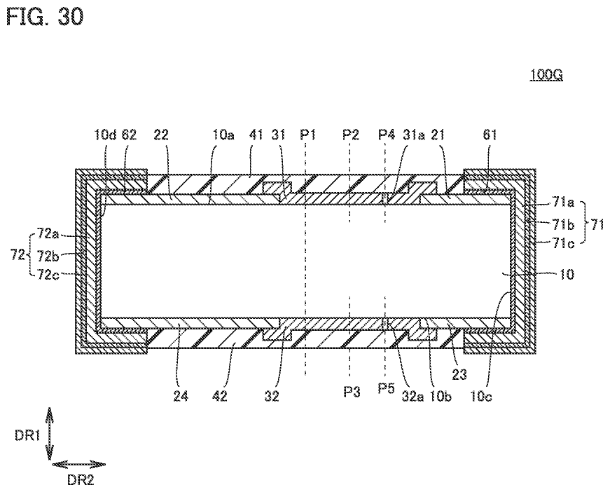

FIG. 30 is a cross-sectional view of chip resistor 100G. FIG. 30 shows a cross section of chip resistor 100G orthogonal to third direction DR3. As shown in FIG. 30, chip resistor 100G includes insulating substrate 10, first front surface electrode 21, second front surface electrode 22, first back surface electrode 23, second back surface electrode 24, first resistor body 31, second resistor body 32, first protective film 41, second protective film 42, first side surface electrode 61, second side surface electrode 62, first plating layer 71, and second plating layer 72. In these respects, chip resistor 100G has the same configuration as that of chip resistor 100F.

In chip resistor 100G, third position P3 is displaced from first position P1 toward first side surface 10c in second direction DR2. In other words, in chip resistor 100G, third position P3 is displaced from first position P1 toward the same side as second position P2. In chip resistor 100G, fifth position P5 is displaced from third position P3 toward first side surface 10c in second direction DR2. In these respects, chip resistor 100G is different in configuration from chip resistor 100F.

Chip resistor 100G exhibits a smaller distance between bonding member 240 and a portion in which second resistor body 32 generates a large amount of heat (i.e., in the vicinity of third position P3 and the vicinity of fifth position P5). Thus, according to chip resistor 100G, the heat generated by second resistor body 32 is easily dissipated from circuit board 200 through bonding member 240, with the result that the heat dissipation performance is improved similarly to chip resistor 100F.

### Ninth Embodiment

The following describes a chip resistor according to the ninth embodiment. The chip resistor according to the ninth embodiment is referred to as a chip resistor 100H. The following mainly describes differences from chip resistor 100F and the same description will not be repeated.

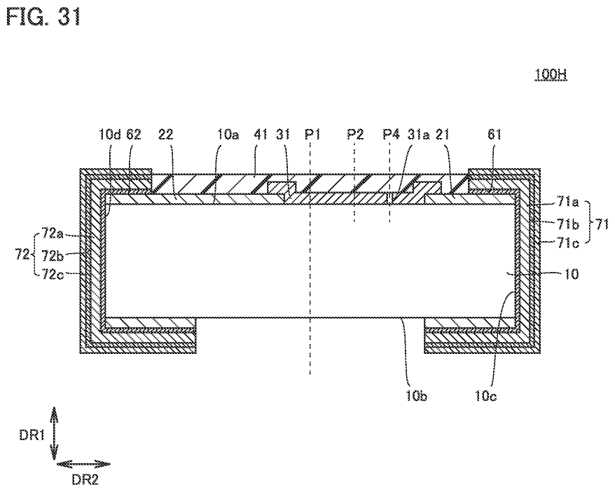

FIG. 31 is a cross-sectional view of chip resistor 100H. FIG. 31 shows a cross section of chip resistor 100H orthogonal to third direction DR3. As shown in FIG. 31, chip resistor 100H includes insulating substrate 10, first front surface electrode 21, second front surface electrode 22, first back surface electrode 23, second back surface electrode 24, first resistor body 31, first protective film 41, first side surface electrode 61, second side surface electrode 62, first plating layer 71, and second plating layer 72. In these respects, chip resistor 100G has the same configuration as that of chip resistor 100F. Chip resistor 100H does not include second resistor body 32 and second protective film 42. In this respect, chip resistor 100H is different in configuration from chip resistor 100F.

Chip resistor 100H exhibits a smaller distance between bonding member 240 and the portion in which first resistor body 31 generates a large amount of heat (i.e., in the vicinity of second position P2 and the vicinity of fourth position P4). Thus, according to chip resistor 100H, the heat generated by second resistor body 32 is easily dissipated from circuit board 200 through bonding member 240, with the result that the heat dissipation performance is improved similarly to chip resistor 100F.

### (Supplementary Notes)

The seventh to ninth embodiments include the following configurations.

### <Supplementary Note 10>

A chip resistor including:
an insulating substrate having a first main surface, a second main surface, a first side surface, and a second side surface, the first main surface and the second main surface each being an end surface in a thickness direction of the chip resistor, and the first side surface and the second side surface each being an end surface in a longitudinal direction of the chip resistor; and
a first resistor body disposed on the first main surface, wherein
a center position of the first resistor body in the longitudinal direction is displaced toward the first side surface from a center position of the insulating substrate in the longitudinal direction.

### <Supplementary Note 11>

The chip resistor according to Supplementary Note 10, further including a second resistor body disposed on the second main surface, wherein
a center position of the second resistor body in the longitudinal direction is displaced toward the first side surface or the second side surface from the center position of the insulating substrate in the longitudinal direction.

### <Supplementary Note 12>

The chip resistor according to Supplementary Note 11, wherein the center position of the second resistor body in the longitudinal direction is displaced toward the second side surface from the center position of the insulating substrate in the longitudinal direction.

### <Supplementary Note 13>

The chip resistor according to Supplementary Note 12, wherein
the first resistor body is provided with a first trimming groove, and
a position of the first trimming groove in the longitudinal direction is displaced toward the first side surface from the center position of the first resistor body in the longitudinal direction.

### <Supplementary Note 14>

The chip resistor according to Supplementary Note 13, wherein
the second resistor body is provided with a second trimming groove, and
a position of the second trimming groove in the longitudinal direction is displaced toward the second side surface from the center position of the second resistor body in the longitudinal direction.

### <Supplementary Note 15>

The chip resistor according to Supplementary Note 14, wherein
the insulating substrate has a third side surface and a fourth side surface each being an end surface in a width direction of the chip resistor,
the first trimming groove extends in the width direction from the third side surface toward the fourth side surface in a plan view, and
the second trimming groove extends in the width direction from the fourth side surface toward the third side surface in a plan view.

### <Supplementary Note 16>

The chip resistor according to any one of Supplementary Notes 12 to 15, further including:
a first front surface electrode and a second front surface electrode disposed on the first main surface;
a first back surface electrode and a second back surface electrode disposed on the second main surface;
a first side surface electrode;
a second side surface electrode;
a first plating layer; and
a second plating layer, wherein
the second main surface is a surface on which the chip resistor is mounted,
the first front surface electrode extends in the longitudinal direction from above an end portion of the first main surface on a side close to the first side surface toward the first resistor body,
the second front surface electrode extends in the longitudinal direction from above an end portion of the first main surface on a side close to the second side surface toward the first resistor body,
the first back surface electrode extends in the longitudinal direction from above an end portion of the second main surface on a side close to the first side surface toward the second resistor body,
the second back surface electrode extends in the longitudinal direction from above an end portion of the second main surface on a side close to the second side surface toward the second resistor body,
the first side surface electrode is disposed on the first side surface, the first front surface electrode, and the first back surface electrode,
the second side surface electrode is disposed on the second side surface, the second front surface electrode, and the second back surface electrode,
the first plating layer and the second plating layer are disposed on the first side surface electrode and the second side surface electrode, respectively, and
a width of the first plating layer in the longitudinal direction that is located on the first back surface electrode with the first side surface electrode interposed therebetween is 100 μm or more, and a width of the second plating layer in the longitudinal direction that is located on the second back surface electrode with the second side surface electrode interposed therebetween is 100 μm or more.

Although the embodiments of the present disclosure have been described above, the embodiments described above can also be variously modified. Further, the scope of the present invention is not limited to the above-described embodiments. The scope of the present invention is defined by the scope of the claims and is intended to include any modifications within the meaning and scope equivalent to the scope of the claims.

### REFERENCE SIGNS LIST

100, 100A, 100B, 100C, 100D, 100E, 100F, 100G, 100H chip resistor, 10 insulating substrate, 10a first main surface, 10aa, 10aaa, 10aab first dividing groove, 10ab second dividing groove, 10b second main surface, 10ba, 10baa, 10bab, first dividing groove, 10bb second dividing groove, 10c first side surface, 10d second side surface, 10e third side surface, 10f fourth side surface, 11 sheet-like substrate, 12 strip-shaped substrate, 21 first front surface electrode, 22 second front surface electrode, 23 first back surface electrode, 24 second back surface electrode, 25 front surface electrode, 25a front surface electrode, 25b front surface electrode, 26 back surface electrode, 26a back surface electrode, 26b back surface electrode, 30 resistor body, 30a trimming groove, 31 first resistor body, 31a trimming groove, 32 second resistor body, 32a trimming groove, 40 protective film, 41 first protective film, 42 second protective film, 51 first conductive resin layer, 52 second conductive resin layer, 53 conductive resin layer, 53a conductive resin layer, 53b conductive resin layer, 54 first heat dissipation film, 55 second heat dissipation film, 61 first side surface electrode, 62 second side surface electrode, 71 first plating layer, 71a first layer, 71b second layer, 71c third layer, 72 second plating layer, 72a first layer, 72b second layer, 72c third layer, 200 circuit board, 210 base member, 220 first land, 230 second land, 240, 250 bonding member, DR1 first direction, DR2 second direction, DR3 third direction, L1, L2, L3, L4 distance, S1 preparing step, S2 first electrode forming step, S3 resistor body forming step, S4 protective film forming step, S5 conductive resin layer forming step, S6 first dividing step, S7 second electrode forming step, S8 second dividing step, S9 plating layer forming step, W, W1, W2 width.

1. A chip resistor comprising:
an insulating substrate having a first main surface, a first side surface, and a second side surface, the first main surface being an end surface in a thickness direction of the chip resistor, and the first side surface and the second side surface each being an end surface in a longitudinal direction of the chip resistor;
a first front surface electrode disposed on an end portion of the first main surface on a side close to the first side surface;
a second front surface electrode disposed on an end portion of the first main surface on a side close to the second side surface;
a resistor body disposed on the first main surface and electrically connected to the first front surface electrode and the second front surface electrode;
a protective film disposed on the resistor body to partially cover the first front surface electrode and the second front surface electrode;
a first conductive resin layer disposed to extend over the first front surface electrode and the protective film; and
a second conductive resin layer disposed to extend over the second front surface electrode and the protective film, wherein
an end of the first conductive resin layer on the side close to the second side surface is spaced apart from an end of the second conductive resin layer on the side close to the first side surface.

2. The chip resistor according to claim 1, wherein the end of the first conductive resin layer on the side close to the second side surface and the end of the second conductive resin layer on the side close to the first side surface overlap with the resistor body in a plan view.

3. The chip resistor according to claim 1, wherein a distance in the longitudinal direction between the end of the first conductive resin layer on the side close to the second side surface and the end of the second conductive resin layer on the side close to the first side surface is 300 μm or more and 700 μm or less.

4. The chip resistor according to claim 1, wherein an end of the first conductive resin layer on the side close to the first side surface and an end of the second conductive resin layer on the side close to the second side surface are respectively spaced apart from an end of the first front surface electrode on the side close to the first side surface and an end of the second front surface electrode on the side close to the second side surface.

5. The chip resistor according to claim 4, wherein
a distance in the longitudinal direction between the end of the first conductive resin layer on the side close to the first side surface and the end of the first front surface electrode on the side close to the first side surface is 100 μm or more,
a distance in the longitudinal direction between the end of the second conductive resin layer on the side close to the second side surface and the end of the second front surface electrode on the side close to the second side surface is 100 μm or more,
a width of a portion of the first conductive resin layer in the longitudinal direction that is located on the first front surface electrode is 100 μm or more, and
a width of a portion of the second conductive resin layer in the longitudinal direction that is located on the second front surface electrode is 100 μm or more.

6. The chip resistor according to claim 4, further comprising a first plating layer and a second plating layer, wherein
the first plating layer and the second plating layer are disposed on the first front surface electrode and the second front surface electrode, respectively.

7. The chip resistor according to claim 1, wherein
the resistor body is provided with a trimming groove, and
one of the first conductive resin layer and the second conductive resin layer overlaps with the trimming groove in a plan view.

8. The chip resistor according to claim 7, wherein the trimming groove is displaced from a center position of the resistor body in the longitudinal direction toward the first side surface or the second side surface.
